(19) United States
(12) Patent Application Publication
(10) Pub. No.: US 2013/0044135 A1
(43) Pub. Date: Feb. 21, 2013

(54) ELECTRONIC BOOK AND METHOD FOR CONTROLLING DISPLAY OF FILES

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/485,973

(22) Filed: Jun. 1, 2012

(30) Foreign Application Priority Data
Aug. 19, 2011 (TW) 100129660

(51) Int. Cl. G09G 5/00

(52) U.S. Cl. 345/660

(57) ABSTRACT

An electronic book (e-book) includes a display screen. When a user reads a file on the display screen, the e-book determines a distance between the user's face and the e-book based on distance information in a captured image of the user. When the distance equals or is more than a first distance, the e-book displays the file in an original size. When the distance equals or is less than a second distance, the e-book displays the file in the original size as multiplied by a maximum multiplying factor. When the distance is more than the second distance and less than the first distance, the e-book adjusts a multiplying factor for the file according to the current distance and the zoom rules, and adjusts the display of the file on the display screen accordingly.

### BACKGROUND

1. Technical Field

The embodiments of the present disclosure relate to automatic control systems and methods, and particularly to an electronic book (e-book) and a method for controlling display of files in the e-book.

2. Description of Related Art

When reading files displayed on a touch screen of an e-book, for clearer reading or better display effect of the files, users may frequently zoom in/zoom out the file by manipulating control buttons (such as zoom in/zoom out buttons) provided by the e-book. Most e-books are not smart enough to know users' demands and automatically adjust the display of the file to suit that user.

### BRIEF DESCRIPTION OF THE DRAWINGS

FIG. 1 is a block diagram of one embodiment of a e-book having a display control unit.

FIG. 2 is a block diagram of one embodiment of function modules of the display control unit in FIG. 1.

FIG. 3A and FIG. 3B show a flowchart of one embodiment of a method for controlling display of files in the e-book in FIG. 1.

FIG. 4A-FIG. 4D show one embodiment illustrating how to enable the function for controlling display of files in the e-book of FIG. 1.

FIG. 5 and FIG. 6 show examples illustrating the capture of a scene in front of the e-book.

FIG. 7A-FIG. 7C illustrate adjustment of the display of a file in the e-book.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

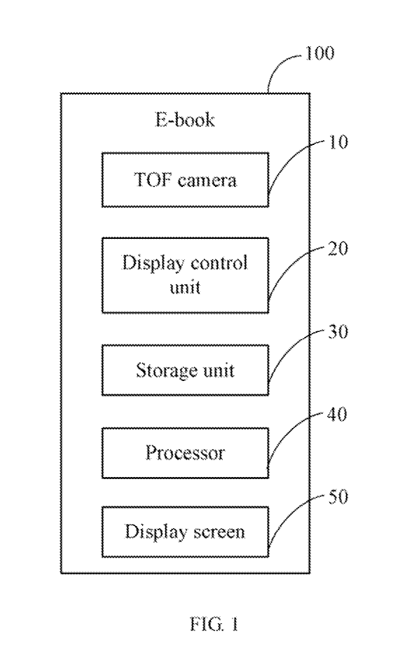

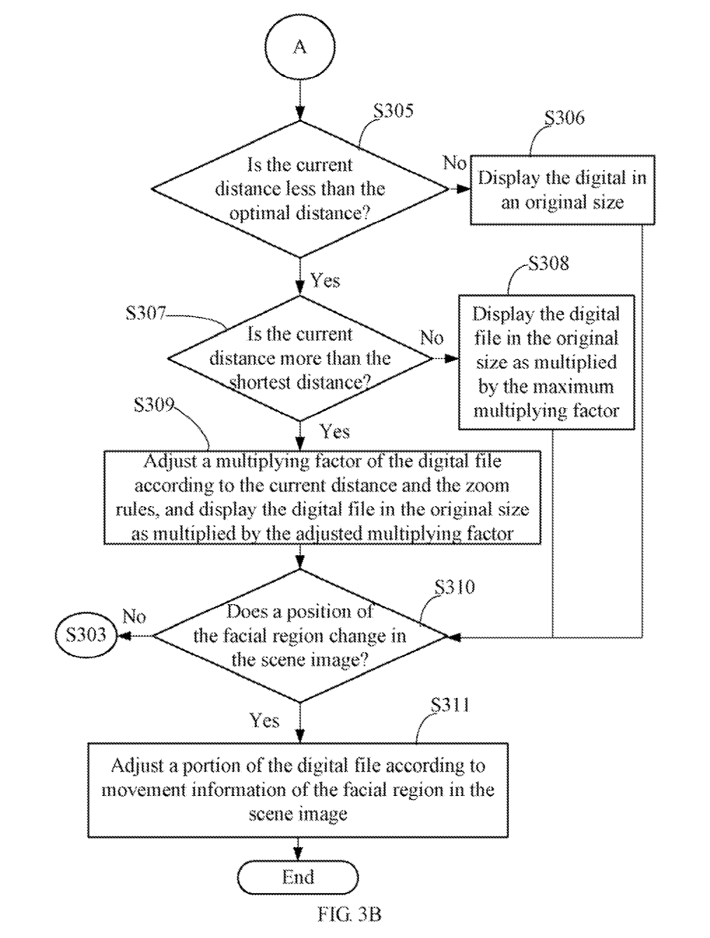

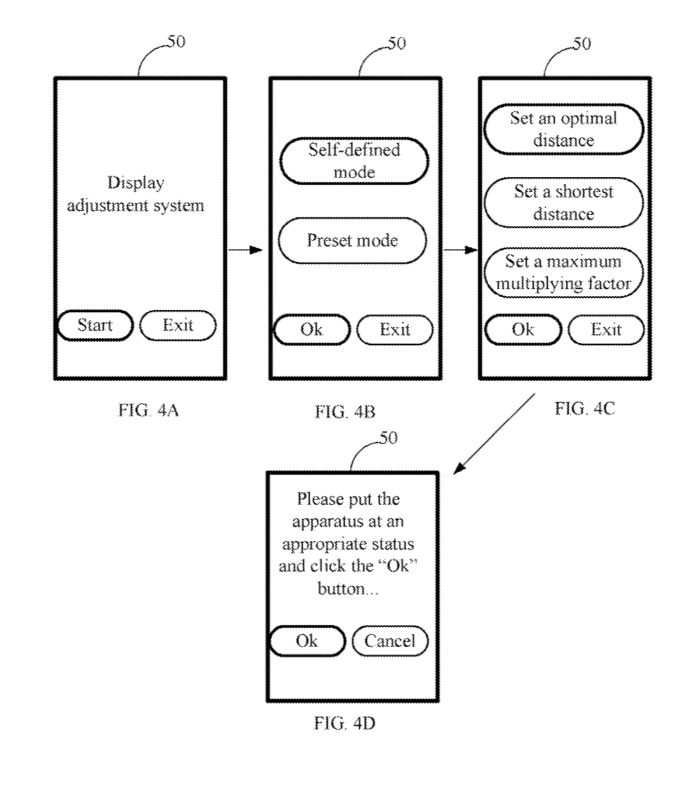

FIG. 1 is a block diagram of one embodiment of an electronic book (e-book) 100 including a display control unit 20 for controlling display of files (“display adjustment system” as shown in FIG. 4) on the e-book 100. In this embodiment, the e-book 100 further includes a time-of-flight (TOF) camera 10, a storage unit 30, a processor 40, and a display screen 50. The TOF camera 10 can facilitate the calculation of distances between a lens of the TOF camera 10 and each point on a captured object, so that each image captured by the TOF camera 10 includes information as to the distances between the lens and each point in the image. In this embodiment, the TOF camera in installed above the display screen 50. The storage unit 30 stores files, such as pictures or videos or files displaying text in digital forms for reading. The display screen 50 displays the files. The storage unit 30 may be a cache or a dedicated memory, such as an erasable programmable read only memory (EPROM), a hard disk driver (HDD), or flash memory.

When a user views files displayed on the display screen 50, the TOF camera 10 captures a scene in front of the screen of the e-book 10 to obtain an image. The display control unit 10 determines information as to the distances between the user's face and the e-book 100 by analyzing the image, and automatically adjusts display of a file by applying a multiplying factor of the file displayed on the display screen 50 according to the determined information.

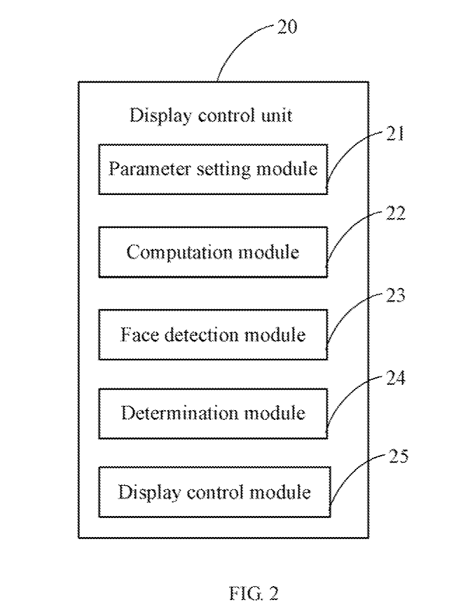

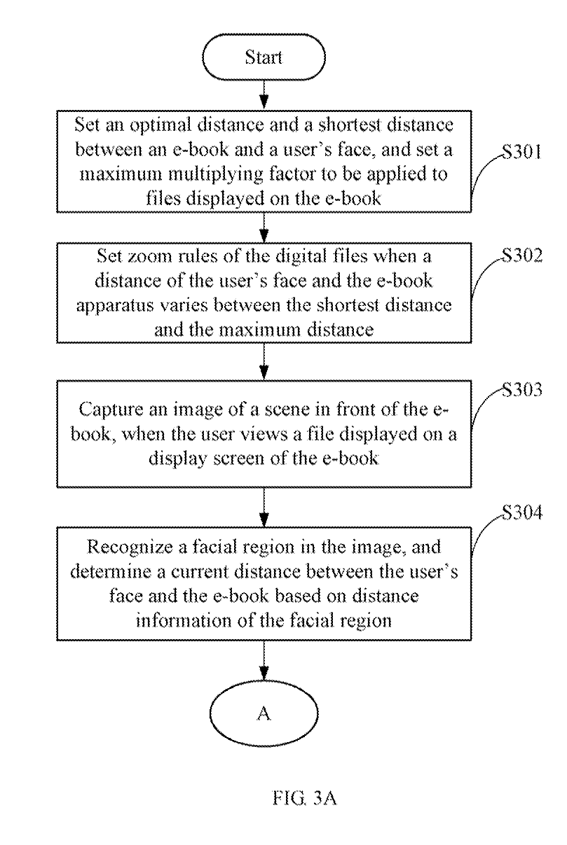

As shown in FIG. 2, the display control unit 20 includes a parameter setting module 21, a computation module 22, a face detection module 23, a determination module 24, and a display control module 25. The modules 21-25 comprise computerized code in the form of one or more programs that are stored in the storage unit 30. The computerized code includes instructions that are executed by the processor 40, to provide the aforementioned functions of the display control unit 20. A description of the functions of the modules 21-25 is given with reference to FIG. 3A and FIG. 3B.

FIG. 3A and FIG. 3B are a flowchart of one embodiment of a method for controlling display of files in the e-book 100. Depending on the embodiment, additional steps may be added, others removed, and the ordering of the steps may be changed.

In step S301, the parameter setting module 21 sets reference parameters for adjustment of display of files displayed on the display screen 50. In one embodiment, the reference parameters include an optimal distance and a shortest distance between a user's face and the e-book 100, and a maximum multiplying factor to be applied to the files. A multiplying factor is a zoom ratio for adjusting display of the files based on an original size of each file. The maximum multiplying factor has the maximum value in all operable multiplying factors. The optimal distance is a distance facilitating protecting the user's eyesight. The shortest distance is a distance less than the optimal distance and the user feels comfortable to hold the e-book 100. In this embodiment, associations between a multiplying factor of the files displayed on the display screen 50 and the shortest distance and the optimal distance are defined as follows: if a distance between the user's face and the e-book 100 equals or is more than the optimal distance (as hereinafter defined), the files are displayed on the display screen 50 in original size (namely the multiplying factor=1 times), such as texts being displayed in a 12 font size, or pictures in 6 cm×8 cm outline size. If the distance between the user's face and the e-book 100 equals or is less than the shortest distance, the files are displayed on the display screen 50 in the original size as multiplied by the maximum multiplying factor. For example, the maximum multiplying factor may be set as 5 times (×5).

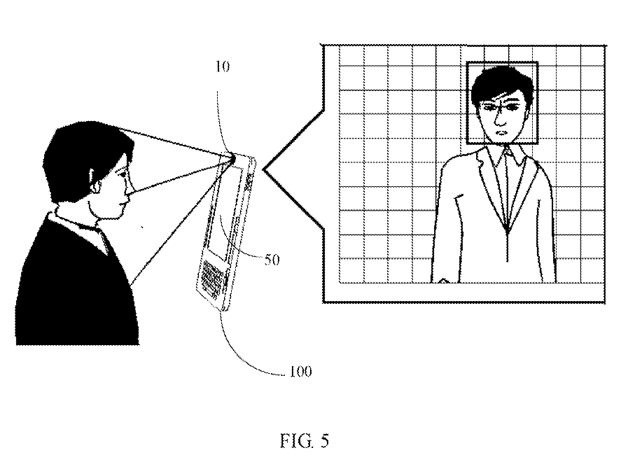

In one embodiment, the optimal distance and the shortest distance may be two static values or two value ranges. For example, the optimal distance may be 30 cm or a value range of 28 cm-33 cm, the shortest distance may be 8 cm or a value range of 7 cm-9 cm. The aforementioned reference parameters may be set under a user-defined mode or under a preset mode. For example, as shown in FIG. 4A-FIG. 4C, when the user starts the function for control display of files provided by the display control unit 20, such as by opening the “display adjustment system,” the icons of the preset mode and the user-defined mode are displayed on the display screen 50 for the user to make a selection. If the user selects the preset mode, the reference parameters are set by a provider of the “display adjustment system,” and are already stored in the storage unit 30. If the user selects the user-defined mode, the user can use the TOF camera 10 and functions provided by the modules 21-25 of the display control unit 10 to set the reference parameters based on the user's reading habits. For example, for setting the optimal distance, the user can put the e-book 100 at an appropriate position in front of the user's face, and use the TOF camera 10 of the e-book 100 to capture one or more images of the user's face (as shown in FIG. 5). Then the face detection module 23 analyzes the one or more images to determine the optimal distance.

In step S302, the parameter setting module 21 sets zoom rules of the files when the distance of the user's face and the e-book 100 varies between the shortest distance and the optimal distance. In one embodiment, for example, the zoom rules may be set by the user as follows: every time the user's face moves closer to the e-book 100 by 2 cm, the current multiplying factor of the files that are displayed on the display screen 50 is increased by 0.2, while every time the use's face moves away from the e-book 100 by 2 cm, the current multiplying factor of the files that are displayed on the display screen 50 is decreased by 0.2.

In other embodiment, the zoom rules may not be set by the user, but be computed by the computation module 22 according to preset associations between multiplying factors of the files displayed on the display screen 50 and the shortest distance and the optimal distance. For example, if 28 cm is the optimal distance corresponding to the files being displayed on the display screen 50 in their original size (i.e., ×1), and 8 cm is the shortest distance corresponding to the files being displayed on the display screen 50 in their original size as multiplied by 5 times (i.e., ×5), then a zoom ratio is calculated as: (28−8)cm/5times=4 cm/1times. Accordingly, the zoom rules would be set as follows: every time the user's face moves closer to the e-book 100 by 4 cm, a current multiplying factor of the files that are displayed on the display screen 50 is increased by 1, while every time the use's face moves away from the e-book 100 by 4 cm, a current multiplying factor of the files that are displayed on the display screen 50 is decreased by 1.

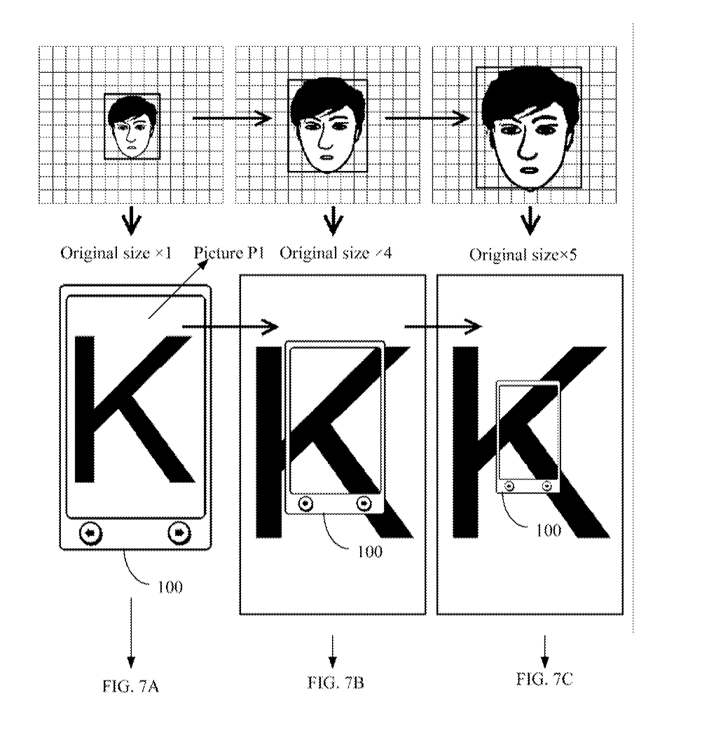

In step S303, when the user is viewing a file (such as a picture P1 shown in FIG. 7A) displayed on the display screen 50, the TOF camera 10 captures an image of a scene in front of the e-book 100. The image includes facial information, such as characteristic points (e.g., eyes, nose, eyebrows) on the user's face and distances between the characteristic points and the lens of the TOF camera 10. The image may further include additional information, such as hair, or a part of the user's clothes, for example.

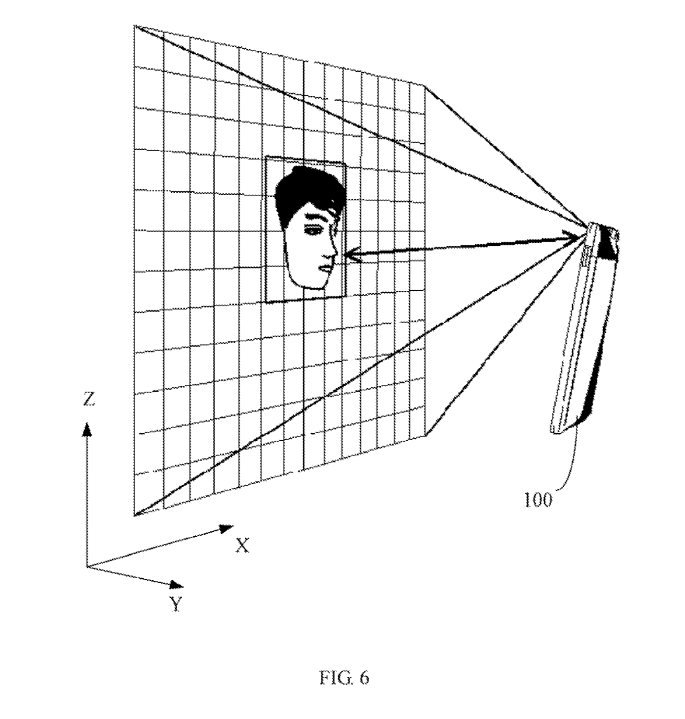

In step S304, the face detection module 23 recognizes a facial region in the image (as shown in FIG. 6) using a face detection method, and determines a current distance between the user's face and the e-book 100 based on distance information of the facial region. The face detection method may include steps of: pre-storing a large number of characteristics data of human faces to create a face sample in the storage unit 30, and analyzing the image by comparing data of the image with the stored characteristics data of the face sample that includes face, eyes and mouth characteristics, and determining whether a facial region is detected in the image according to the comparison. In one embodiment, the current distance between the user's face and the e-book 100 may be an average of the distances between each point on the user's face and the lens of the TOF camera 10, or a particular distance between a characteristic point (e.g., the point between the eyes) on the user's face and the lens of the TOF camera 10.

In step S305, the determination module 24 determines if the current distance is less than the optimal distance (such as 30 cm). If the current distance equals or is more than the optimal distance, step S306 is implemented. If the current distance is less than the optimal distance, step S307 is implemented.

In step S306, the display control module 15 displays the file on the display screen 50 in an original size (as shown in FIG. 7A), such as texts in a 12 font size, pictures in a 6 cm×8 cm size. Then, the procedure goes to step S310.

In step S307, the determination module 24 determines if the current distance is more than the shortest distance (such as 8 cm). If the current distance equals or is less than the shortest distance, step S308 is implemented, the display control module 15 displays the file on the display screen 50 in the original size as multiplied by the maximum multiplying factor (such as ×5) (as shown in FIG. 7C). Then, the procedure goes to step S310. Otherwise, if the current distance is less than the optimal distance, step S309 is implemented.

In step S309, the display control module 25 adjusts a multiplying factor for the file according to the current distance and the zoom rules, and displays the file on the display screen 50 in the original size as multiplied by the adjusted multiplying factor. For example, if the optimal distance is 28 cm, the shortest distance is 8 cm, the maximum multiplying factor is 5 times, the zoom ratio R=(28−8)cm/5times=4 cm/1times, and the current distance is 2, then the adjusted multiplying factor is determined as (24−8)cm/R=4 times. Accordingly, the display control module 15 displays the file on the display screen 50 in the original size as multiplied by a factor of 4 (as shown in FIG. 7B).

In step S310, the determination module 24 determines if a position of the facial region changes in the image. If the position of the facial region does not change in the image, the procedure returns to step S303. Otherwise, if the position of the facial region changes in the image, step S311 is implemented.

In step S311, the display control module 25 recognizes movements, such as a movement direction and a movement distance of the facial region in the image, and determines adjustments to a portion of the file according to preset associations between the movements of the facial region and the adjustments to the portion of the file, to display a different portion of the file on the display screen 50. The preset associations between the movements of the facial region and the adjustments to the portion of the file are set for the setting module 21 and stored in the storage unit 30. For example, preset associations may include that if a center of the facial region moves along a direction (such as move leftwards) in the image by a first distance (such as 0.1 cm) then the portion of the file is moved along an opposite direction (such as move leftwards) on the display screen 50, by a second distance such as 0.5 cm.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of an electronic book (e-book) for controlling display of files displayed on a display screen of the e-book, the method comprising:
setting reference parameters for adjusting display of files displayed on the display screen, the reference parameters comprising an optimal distance and a shortest distance between a user's face and the e-book, and a maximum multiplying factor of the files;
setting zoom rules of the files when a distance of the user's face and the e-book varies between the shortest distance and the optimal distance;
using a time-of-flight (TOF) camera to capture an image of a scene in front of the e-book, when the user views a file displayed on the display screen;
recognizing a facial region in the image, and determining a current distance between the user's face and the e-book based on distance information of the facial region in the image; and
displaying the file on the display screen in an original size when the current distance is equal to or more than the optimal distance, or displaying the file on the display screen in the original size as multiplied by the maximum multiplying factor when the current distance is equal to or less than the shortest distance, or adjusting a multiplying factor for the file according to the current distance and the zoom rules and displaying the file on the display screen in the original size as multiplied by the adjusted multiplying factor when the current distance is more than the shortest distance and less than the optimal distance.

2. The method of claim 1, further comprising:
recognizing movements of the facial region in the image; and
determining an adjustment to a portion of the file according to preset associations between the movements of the facial region and adjustments to the portion of the file, to display a different portion of the file on the display screen.

3. The method of claim 2, wherein information in relation to the movements comprises a movement direction and a movement distance of the facial region in the image.

4. The method of claim 1, wherein the optimal distance and the shortest distance are two static values or two value ranges.

5. The method of claim 1, wherein The TOF camera obtains a distance between a lens of the TOF camera and each point on an object to be captured, so that each image captured by the TOF camera comprises the distance information between the lens and each point on the object in the image.

6. The method of claim 1, wherein the zoom rules are set by the user, or be computed according to preset associations between multiplying factors of the files and the shortest distance and the optimal distance.

7. The method of claim 6, wherein a multiplying factor is a zoom ratio for adjusting display of the files based on original sizes of the files.

8. An electronic book (e-book), comprising:
a storage unit that stores a plurality of files;
a display screen;
a time-of-flight (TOF) camera that captures an image of a scene in front of the e-book and records distance information between a lens of the TOF camera and each point on the scene in the image, when a user views a file displayed on the display screen;
at least one processor; and
a display control unit comprising one or more programs executable by the at least one processor, the one or more programs comprising instructions to:
set reference parameters for adjustment of display of files displayed on the display screen, the reference parameters comprising an optimal distance and a shortest distance between a user's face and the e-book, and a maximum multiplying factor to be applied to the files;
set zoom rules of the files when a distance of the user's face and the e-book varies between the shortest distance and the optimal distance;
recognize a facial region in the image, and determine a current distance between the user's face and the e-book based on distance information of the facial region in the image; and
display the file on the display screen in an original size when the current distance is equal to or more than the optimal distance, or display the file on the display screen in the original size as multiplied by the maximum multiplying factor when the current distance is equal to or less than the shortest distance, or adjust a multiplying factor for the file according to the current distance and the zoom rules and display the file on the display screen in the original size as multiplied by the adjusted multiplying factor when the current distance is more than the shortest distance and less than the optimal distance.

9. The e-book of claim 8, wherein the one or more programs further comprise instructions to store the image, the reference parameters, and the zoom rules into the storage unit.

10. The e-book of claim 8, wherein the one or more programs further comprise instructions to:
recognize movements of the facial region in the image; and
determine an adjustment to a portion of the file according to preset associations between the movements of the facial region and adjustments to the portion of the file, to display a different portion of the file on the display screen.

11. The e-book of claim 10, wherein information in relation to the movements comprises a movement direction and a movement distance of the facial region in the image.

12. The e-book of claim 8, wherein the optimal distance and the shortest distance are two static values or two value ranges.

13. The e-book of claim 8, wherein the zoom rules are set by the user, or be computed according to preset associations between multiplying factors of the files and the shortest distance and the optimal distance.

14. The e-book of claim 13, wherein a multiplying factor is a zoom ratio for adjusting display of the files based on original sizes of the files.

15. A non-transitory computer-readable medium storing a set of instructions, the set of instructions capable of being executed by a processor of an electronic book (e-book) to control display of files displayed on a display device of the e-book, the method comprising:
setting reference parameters for adjustment of display of files displayed on the display screen, the reference parameters comprising an optimal distance and a shortest distance between a user's face and the e-book, and a maximum multiplying factor to be applied to the files;
setting zoom rules of the files when a distance of the user's face and the e-book varies between the shortest distance and the optimal distance;
using a time-of-flight (TOF) camera to capture an image of a scene in front of the e-book, when the user viewing a file displayed on the display screen;
recognizing a facial region in the image, and determining a current distance between the user's face and the e-book based on distance information of the facial region in the image; and
displaying the file on the display screen in an original size when the current distance is equal to or more than the optimal distance, or displaying the file on the display screen in the original size as multiplied the maximum multiplying factor when the current distance is equal to or less than the shortest distance, or adjusting a multiplying factor for the file according to the current distance and the zoom rules and displaying the file on the display screen in the original size as multiplied the adjusted multiplying factor when the current distance is more than the shortest distance and less than the optimal distance.

16. The medium of claim 15, wherein the method further comprises:
recognizing movements of the facial region in the image; and
determining an adjustment to a portion of the file according to preset associations between the movements of the facial region and adjustments to the portion of the file, to display a different portion of the file on the display screen.

17. The medium of claim 15, wherein the optimal distance and the shortest distance are two static values or two value ranges.

18. The medium of claim 15, wherein The TOF camera obtains a distance between a lens of the TOF camera and each point on an object to be captured, so that each image captured by the TOF camera comprises the distance information between the lens and each point on the object in the image.

19. The medium of claim 15, wherein the zoom rules are set by the user, or be computed according to preset associations between multiplying factors of the files and the shortest distance and the optimal distance.

20. The medium of claim 19, wherein a multiplying factor is a zoom ratio for adjusting display of the files based on original sizes of the files.
